(19) United States
(12) Patent Application Publication
(10) Pub. No.: US 2016/0091248 A1
(43) Pub. Date: Mar. 31, 2016

(54) COMBUSTION SYSTEM AND METHOD FOR HEATING PROCESS AIR FOR PAPER DRYING SYSTEMS

(71) Applicant: NOVIMPIANTI DRYING TECHNOLOGY S.R.L., Marliacapannori (LU) (IT)

(72) Inventors: Pietro SACCOMANO, Lucca (IT); Massimo GIANNECCHINI, Palmata (LU) (IT)

(21) Appl. No.: 14/889,240

(22) PCT Filed: May 9, 2014
(86) PCT No.: PCT/IB2014/061330

§ 371 Date: Nov. 5, 2015

(30) Foreign Application Priority Data
May 10, 2013 (IT) MI2013A 000775

(51) Int. Cl. F26B 21/00; F26B 23/02

(52) U.S. Cl. CPC F26B 21/001; F26B 23/02

(57) ABSTRACT

A system for drying a web-like paper sheet is disclosed which includes a drying device capable of blowing pressurized high temperature dry air through inlet conduits on the web-like paper sheet, and of sucking moist air, ejected through outlet conduits connected to a recirculation conduit, and a combustion system which has a hot gas generator, provided with systems for supplying fuel and combustion air. The hot gas generator consists of a burner, and a combustion chamber. Outside the combustion chamber a cooling channel is provided, which encloses the combustion chamber. The cooling channel is downstream of the burner and is connected to the recirculation conduit, so that the hot gas generator generates an air and burnt gases mixture which forms the dry air, as well as receiving, through such a recirculation conduit, part of the moist air so that it can be heated and reused.

The present invention refers to a combustion system and to a method for heating the process air for a system for drying paper, in particular but not exclusively, for a system for producing rolls of toilet paper.

As known, in the process of making paper in general, and in particular in that of toilet paper, it is necessary to carry out a step of drying of the product being processed through evaporation, so as to extract the excess water content. The product that must be dried, normally made up of a mixture of paper that is diluted with water, is prepared and conveyed to a drying and desiccation system after a preliminary pressing step. When the sheet of paper being processed is introduced into the drying and desiccating system, it has a low content of solid part, equal to around 35%-40% at a temperature of around 35° C. In other words, after the pressing step the sheet of paper being processed can still contain up to 65% water. The pressing step, therefore, is not capable of eliminating all of the water from the paper fibres, which must thus be removed through evaporation.

The end product, typically but not exclusively consisting of toilet paper, requires a content of solid part that is much greater than the values mentioned above. It is thus evident that there is a need of extracting from the sheet of paper, in the evaporation drying step, most of the residual water content thereof, so as to obtain a web-like paper sheet that is sufficiently dry. After the evaporation drying and desiccation step, the sheet of paper is arranged in reels so as to be subsequently processed (so-called “converting” step) and finally packed for shipping and the final retail selling.

The continuous cycle of drying and desiccation of the paper through evaporation, like for example toilet paper, is obtained with a system that is provided with two separate devices, which, however, act simultaneously on the sheet of paper during such a drying and desiccation step. A first drying device consists of a high performance hood, which provides for blowing hot air, at a temperature that can be greater than 700° C., on the sheet of paper being processed. The hot air is normally produced with a hot gas generator of the direct type. By direct type hot gas generator we commonly mean a hot gas generator in which the combustion develops directly in the flow of mass of fluid to be heated.

Simultaneously with respect to the blowing, the sheet of paper being processed is placed in contact with the surface of a steam heated cylinder, normally having a diameter that can be of between around 1.5 m and around 6 m. This cylinder, which is usually identified as a “Yankee” cylinder, is typically made up of a pressurised recipient containing, inside it, process steam of up to about 10 bar G and more.

For example, document EP 2 298 988 A1 to the same Applicant shows a system of the known type for drying paper according to the preamble of claim 1. Document GB 1 034 213 A, on the other hand, illustrates a particular embodiment of a hot gas generator that could be used in a similar system for drying paper.

In current continuous desiccation cycles, like in the case of toilet paper but not only, the high temperature moist air or “fumes”, which is extracted from the sheet of paper being processed through the hood, is at least partially recycled. In other words, part of the desiccation air, together with the evaporated water, is sucked by a special fan so as to be reintroduced in the hot gas generator, where it is heated again to then be blown on the paper to be dried.

One part of the high temperature moist air that is extracted from the hood is on the other hand ejected into the atmosphere, so as to take away the mass of evaporated water. The ejection into the atmosphere further concerns the burnt gases coming out from the hot gas generator, and a certain amount of air coming from external infiltrations, which are unavoidable due to the fact that the drying and desiccation cycle is semi-open. This is where there is the main heat loss which reduces the performance of the drying and desiccation process.

Current hot gas generators of the direct type introduce, in the drying and desiccating system, in a ratio that is greater than the stoichiometric ratio, all the combustion air that is necessary for combustion, taking it from the atmosphere. Despite being able to be heated in special air/air heat exchangers, the combustion air remains at a relatively low temperature, thus leading to a heat loss and a combustion that is often incomplete.

It is also worth noting that in order to contain the temperature of the flame, which creates problems in terms of mechanical resistance to the piping material, and in terms of the formation of nitrogen oxides (NOₓ) which exceed the limits set by anti-pollution standards of the individual nations concerned, it is normal practice to increase the stoichiometric ratio until values are reached corresponding to the values of the Lambda index which are equal to 1.5-1.6 (with limit values of 2-3). This means that the amounts of combustion air that is introduced in the system can be from 50% to 300% too high.

The purpose of the present invention is therefore that of making a combustion system and a method for heating the process air for a system for drying paper, in particular but not exclusively for a system for making rolls of toilet paper, which is capable of solving the aforementioned drawbacks of the prior art in an extremely simple, cost-effective and particularly functional manner.

In detail, one purpose of the present invention is to make a combustion system for heating the process air for a system for drying paper that is capable of using both fuels of the conventional type, like for example natural gas or LPG, and fuels of different nature, in the form of gas or nebulised liquid.

Another purpose of the present invention is to make a combustion system and a method for heating process air for a system for drying paper that is capable of limiting the use of combustion air from the atmosphere, fully or partially drawn from the oxygen available in the process air. In such a way it is possible to reduce the mass of fumes extracted, increasing its titre (intended as grams of water by kilogram of dry air) and therefore substantially reducing heat losses at the chimney.

These purposes according to the present invention are achieved by making a combustion system and a method for heating the process air for a system for drying paper, in particular but not exclusively for a system for producing rolls of toilet paper, as outlined in the independent claims.

Further characteristics of the invention are highlighted by the dependent claims, which are an integrating part of the present description.

The characteristics and the advantages of a combustion system and of a method for heating the process air for a system for drying paper according to the present invention shall become clearer from the following description, given as an example and not for limiting purposes, with reference to the attached schematic drawings, in which:

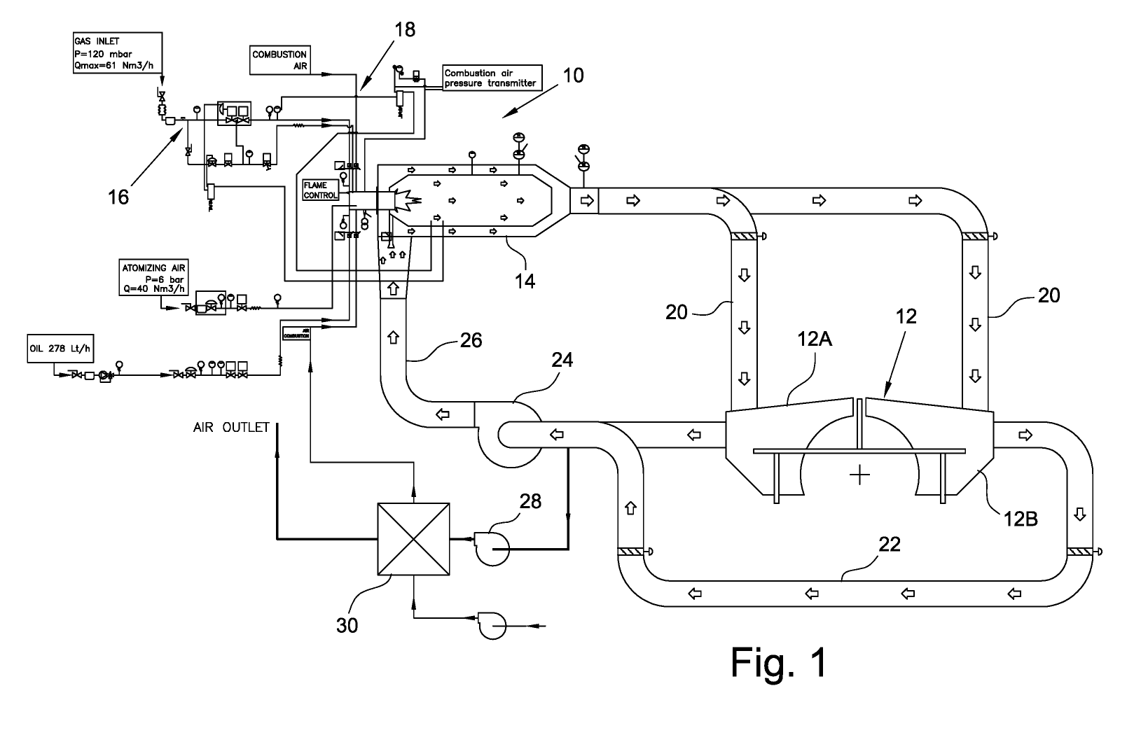

FIG. 1 is a schematic view of a system for drying and desiccating paper provided with a combustion system for heating the process air according to the present invention; and

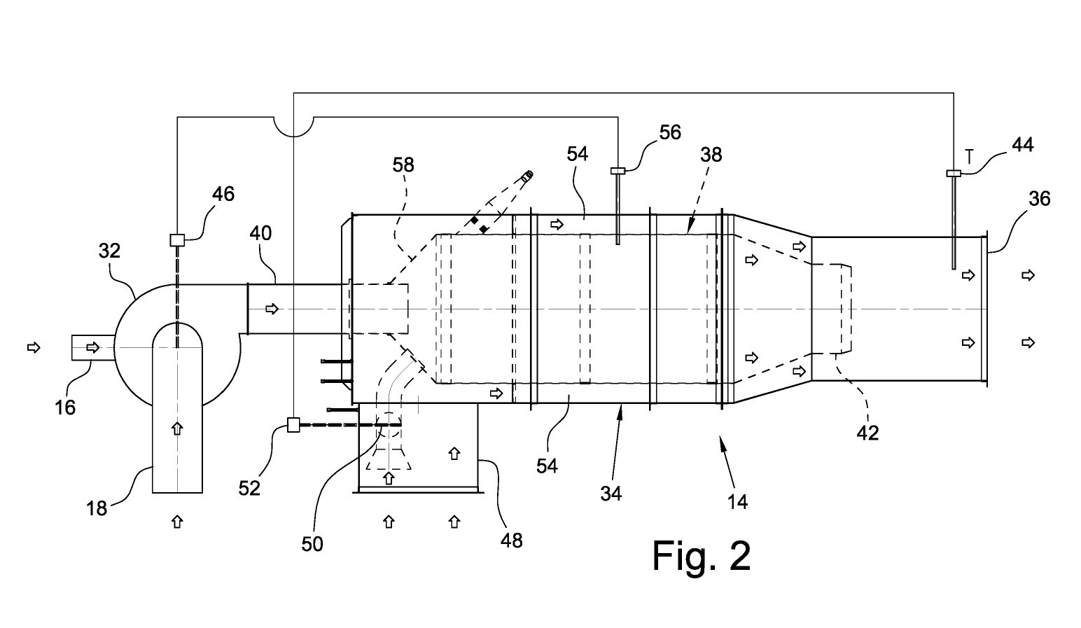

FIG. 2 is a schematic view of a preferred embodiment of a direct hot gas generator that can be used in the combustion system for heating the process air according to the present invention.

With reference in particular to FIG. 1, this schematically shows a system for drying and desiccating paper that is provided with a combustion system for heating the process air according to the present invention. The combustion system is wholly indicated with reference numeral 10.

The system for drying and desiccating paper comprises, in a per se known manner, a drying device 12 of the hood type that at least partially wraps around a cylinder that is heated with steam (Yankee cylinder, which is not shown). The hood 12 is capable of blowing high temperature dry air on a web-like paper sheet wrapped around the cylinder that is heated with steam, and of sucking the moist air or fumes, also at high temperature, that is released from the sheet of paper itself during its desiccation step. Typically, the dry air that is blown by the hood 12 has a temperature that can be greater than 700° C., whereas the moist air that is extracted from the sheet of paper has a temperature that can be greater than 450° C.

The high temperature dry air, that is blown from the hood 12, is produced by a hot gas generator 14 of the so-called direct type, which uses a fuel that is supplied through a corresponding system 16 for supplying fuel. The air that is drawn from the atmosphere is used as a combustion agent and is conveyed, through a corresponding system 18 for supplying combustion air, to the hot gas generator 14 itself.

The burnt air and gas mixture coming out from the hot gas generator 14 constitutes the dry drying and desiccation air, which is supplied under pressure to the hood 12 through one or more inlet conduits 20. As shown in FIG. 1, the hood 12 can preferably be made up of two separate semi-hoods 12A and 12B (“dry-hood” and “wet-hood”). Consequently, each semi-hood 12A or 12B can be provided with its own individual inlet conduit 20 for the dry drying and desiccating air.

The moist air high temperature that is extracted from the sheet of paper being processed through the hood 12, which is usually called process air, is on the other hand ejected through one or more outlet conduits 22 and is at least partially conveyed, by means of a recirculation fan 24 and by a relative recirculation conduit 26 that is connected to it, to the hot gas generator 14 so that it can be heated and reutilised by the hood 12 itself for drying the sheet of paper. Before being definitively ejected from the system, the remaining part of process air that is extracted from the hood 12 is finally conveyed, through the outlet conduits 22 and by means of an ejection fan 28, towards an air/air heat exchanger 30 (which is not always installed in the system), where it gives off part of its heat to the combustion atmospheric air that is conveyed to the hot gas generator 14 through the respective system 18 for supplying combustion air.

With reference now to FIG. 2, a preferred embodiment of the hot gas generator 14 shall now be shown. As previously mentioned, the hot gas generator is of the so-called direct type, i.e. a hot gas generator in which the combustion develops directly in the flow of the mass of fluid to be heated. The direct hot gas generator 14 consists, in a per se known manner, of a burner 32 and of a combustion chamber 38, which is placed downstream of such a burner 32. The burner is provided with a valve 46 for controlling the supply of primary combustion air.

The combustion chamber 38 is preferably cylindrical-shaped and is provided with an outlet port 36 having a tapered and converging shape, i.e. with a decreasing diameter in the direction of the fluid flow with respect to the average diameter of the combustion chamber 38 itself. The outlet port 36 is thus placed in direct fluid communication with the inlet conduits 20 for the dry drying and desiccation air.

The combustion chamber 38 is manufactured with a refractory material and it is placed in direct fluid communication with the burner 32 by interposing a connection conduit 40, also manufactured with a refractory material. The combustion chamber 38 is substantially cylindrical-shaped, or is in any case compatible with the shape of a cooling channel 34 that encloses it, and it preferably extends in the same axial direction of extension of such a cooling channel 34.

As shown in FIG. 2, the combustion chamber 38 preferably has a length in the axial direction that is substantially greater than half of the length of the cooling channel 34, also measured in the axial direction. The combustion chamber 38 is moreover provided, at the front terminal end thereof, with a conveyor nozzle 42 with a converging section facing the outlet port 36 of the cooling channel 34. The combustion chamber 38 is configured so as to perform the function of containing the flame which develops through the connection conduit 40 of the burner 32 and so as to maintain the air and gas mixture inside it at a predefined temperature for a period of time that is required to complete the combustion process.

The process air that is conveyed by the recirculation conduit 26 is introduced in a port 48 that is placed in direct fluid communication with the cooling channel 34, and with the relative combustion chamber 38. The port 48 is provided with a corresponding valve 50 and with motor-driven actuation means 52 for actuating such a gate valve 50. The valve 50 is thus capable of controlling the amount of process air that is supplied in the hot gas generator 14, and of selectively deviating the flow of such a process air, which can thus be partially directly conveyed to the cooling channel 34 and partially to the relative combustion chamber 38 for the reasons that are explained in the rest of the description.

The cooling channel 34 is provided, at its outlet port 36, with at least one temperature sensor device 44 that is adapted to control the temperature of the air and burnt gases mixture that is produced by the hot gas generator 14 and that must be conveyed to the system for drying and desiccating paper through the respective inlet conduits 20. The temperature sensor device 44 is indeed capable of adjusting the mass of recirculation air to be introduced inside the combustion chamber 38 through the actuation of the motor-driven actuation means 52 of the valve 50. In such a way, by varying the mass of gas coming out from the conveyor nozzle 42, at a fixed high temperature (normally at 800° C. and higher), it is possible to control the temperature of the blowing gases coming out, after being mixed, from the outlet port 36 of the cooling channel 34 and directed towards the hood 12.

With this adjustment system, by supplying more or less heat energy to the main flow of process air entering through the port 48, the mass of that part of mixture of air and burnt gases produced by the hot gas generator 14 that comes out, at high temperature, from the single combustion chamber 38 increases or decreases. The adjustment system also makes it possible, following the mixing between the combustion air entering the burner 32 through the respective system 18 for supplying combustion air (primary combustion air) and the process air that directly enters the combustion chamber 38 and/or the cooling channel 34 coming from the port 48, to set, to the required value, the final temperature of such a mixture of air and of burnt gases that are expelled from the outlet port 36 of the cooling channel 34. In any case, the process air that is introduced in the combustion chamber 38 through the valve 50 participates in the combustion process with its own amount of oxygen, making it possible to reduce the supply of cold external combustion air.

The residual flow rate of process air, which is not introduced inside the combustion chamber 38, is conveyed to the interspaces 54 formed between the outer walls of such a combustion chamber 38 and the inner walls of the cooling channel 34. This part of the process air is used to cool the walls of the combustion chamber 38 that would otherwise, despite being made of refractory stainless steel that can withstand high temperatures, could not withstand the heat load they are subjected to.

It is also worth observing that the rear terminal end 58, or “base”, of the combustion chamber 38, which connects such a combustion chamber 38 with the connection conduit 40, is at least partially wrapped by the cooling channel 34. This configuration, which is illustrated in FIG. 2, makes it possible to improve the cooling capability of the walls of the rear terminal end 58 of the combustion chamber 38, which typically reaches temperatures that are rather high during the operation of the hot gas generator 14.

The particular configuration of the combustion chamber 38 of the hot gas generator 14 according to the present invention makes it possible to use fuels other than natural gas and from LPG, which to this day have been scarcely used for combustion systems for systems for drying and desiccating paper, whether in the gas form or in the liquid form.

Indeed, by using a dual-fuel burner 32 and with the provision of suitably increasing the combustion chamber 38 to a dimension such as to allow the fumes to reside for a period of time that is sufficiently high and in any case greater than a second, it is guaranteed for there to be the complete oxidation of all the organic parts in every load condition. In these conditions the combustion chamber 38 has a function that is similar to that of an incinerator. Consequently, the burnt air and gas mixture in outlet from the conveyor nozzle 42 is without unburned substances and has a low content of pollutants, like for example carbon monoxide (CO) and nitrogen oxides (NOₓ), as well as of solid organic particles.

Among the alternative fuels to natural gas and LPG it is also worth mentioning the so-called “low-grade” fuels, that are obtained for example from biomass, from municipal solid waste or from industrial waste. This capability of the burner 32 of being able to burn lower-grade fuels, that are an alternative to natural gas, thanks to the particular shape of the combustion chamber 38, controlled at high temperatures, and to the fumes residing for a time period that is sufficiently long and in any case greater than a second, allows the combustion chamber 38 to operate as an incinerator using multiple fuels with a wide range of heat values.

In the case in which alternative fuels are used with respect to natural gas and LPG, as previously indicated, it is provided for the heating of the combustion chamber 38 to occur with the help of natural gas or LPG. The heating occurs through the reading of a temperature probe 56, which is operatively connected to the combustion chamber 38, and the modulation of the burner 32 with the reaching of a set temperature, which is stabilised on values of between 800° C. and 1100° C.

The method for heating the process air according to the present invention thus occurs in the following way. The combustion chamber 38 is maintained at a preset temperature (around 800° C.-1100° C.) whereas through the temperature sensor device 44, which acts upon the valve 50, the mass of gases in outlet from the conveyor nozzle 42 is adjusted and, consequently, the blowing temperature in the hood. It is therefore possible to make the heat load of the combustion system 10 suitable for the drying requirement of the system.

A first adjustment step, carried out on the burner 32, consists of adjusting the temperature to values such as to have the complete oxidation of the fuel inside the combustion chamber 38 and, consequently, the emission of a minimum amount of pollutants and of unburned substances. A second adjustment step consists of the controlled adjustment of process air inside the combustion chamber 38 (secondary combustion air) that is rich in oxygen in an amount that is large enough, following the heating in the combustion chamber 38 and of the mixing with the primary air combustion, so as to allow air to be conveyed at a preset temperature to the hood 12 of the system for drying paper.

It has thus been seen that the combustion system and the method for heating the process air for a system for drying paper according to the present invention achieve the purposes that were previously highlighted.

In particular, concerning the containment of atmospheric pollution, it has been found that the difference with respect to known types of systems is the following:
from typical values of around 40 ppm, carbon monoxide (CO) drops to values that are lower than 10 ppm;
from typical values of around 80 ppm, nitrogen oxides (NOₓ) drops to values that are lower than 20 ppm;
the stoichiometric ratio of the external combustion air, which is normally equal to around 1.5, can be reduced to values that are lower than 1.

Concerning the electrical part of the system, due to a smaller load loss in the combustion chamber, it is possible to obtain an energy saving equal to about 10%.

The combustion system and the method for heating the process air for a system for drying paper of the present invention thus conceived can in any case undergo numerous modifications and variants, all covered by the same inventive concept; moreover, all the details can be replaced by technically equivalent elements. In practice the materials used, as well as the shapes and dimensions, can be any according to the technical requirements.

The scope of protection of the invention is thus defined by the attached claims.

1. System for drying a web-like paper sheet, comprising:
at least one drying device capable of blowing high temperature dry air, supplied under pressure through one or more inlet conduits, on a web-like paper sheet, and of sucking from said web-like paper sheet moist air, ejected through one or more outlet conduits connected to a recirculation conduit; and
a combustion system which comprises at least one hot gas generator of the so-called direct type, provided with a system for supplying fuel and a system for supplying combustion air,
wherein the hot gas generator consists of a burner, operatively connected to the system for supplying fuel and to the system for supplying combustion air, and a combustion chamber, wherein said combustion chamber is placed in direct fluid communication with the burner by interposing a connection conduit, said combustion chamber being configured to perform the function of containing the flame which develops through said connection conduit and to maintain therein the air and gas mixture at a predefined temperature for a period of time required to complete the combustion process, and wherein, outside the combustion chamber, at least one cooling channel is provided which encloses said combustion chamber, said cooling channel being placed downstream of said burner and being operatively connected to the recirculation conduit, so that the hot gas generator is capable of generating an air and burnt gases mixture which forms said dry air, as well as receiving, through said recirculation conduit, at least part of said moist air so that it can be heated and reused by the drying device, the hot gas generator being also provided with a port placed in direct fluid communication with the cooling channel, and with the combustion chamber, said port being provided with a valve capable of controlling the amount of recirculation air to be introduced into the combustion chamber, so that it takes part in the combustion process with its own amount of oxygen, and of conveying part of said recirculation air into the cooling channel, so that it is conveyed into the interspaces formed between the outer walls of the combustion chamber and the inner walls of the cooling channel, so as to cool said combustion chamber.

2. System according to claim 1, wherein the cooling channel is provided with at least one temperature sensor device adapted to control the temperature of the air and burnt gases mixture, said temperature sensor device being capable of controlling motor-driven actuation means of said valve so that the temperature of the air mixture to be conveyed to the drying device can be automatically adjusted according to preset values.

3. System according to claim 2, wherein the combustion chamber is provided with a temperature probe which, operating on the actuation of the burner, maintains a predefined temperature.

4. System according to claim 1, wherein the cooling channel is cylindrical-shaped and provided with an outlet port having a tapered and converging shape, with a decreasing diameter in the direction of the fluid flow with respect to the average diameter of said cooling channel, said outlet port being placed in direct fluid communication with said inlet conduits for the dry air.

5. System according to claim 4, wherein the combustion chamber is substantially cylindrical-shaped and extends in the same axial direction of extension as the cooling channel.

6. System according to claim 5, wherein the combustion chamber has a length in the axial direction substantially greater than half the length of the cooling channel, also measured in the axial direction.

7. System according to claim 4, wherein the combustion chamber is provided, at the front terminal end thereof, with a conveyor nozzle with a converging section facing the outlet port of the cooling channel.

8. System according to claim 1, wherein the cooling channel is configured so as to at least partially wrap around the rear terminal end or “base” of the combustion chamber, which connects said combustion chamber to the connection conduit, so as to improve the cooling capability of the walls of said rear terminal end or “base” of the combustion chamber.

9. System according to claim 1, wherein both the combustion chamber, and the relative connection conduit are made of a refractory material.

10. System according to claim 1, further comprising an air/air heat exchanger arranged at said outlet conduits for the moist air, said air/air heat exchanger recovering part of the heat of said moist air to transfer it to the combustion air conveyed to the hot gas generator through the respective system for supplying combustion air.

11. Method for heating the process air in a system for drying a web-like paper sheet according to claim 1, comprising of:
performing a modulating control of the temperature in the combustion chamber;
performing a modulating control of the moist air flow rate in the combustion chamber and the cooling channel to guarantee the temperature required for the process air;
adjusting the burner temperature on such values as to allow the complete oxidation of the fuel in the combustion chamber and the emission of a minimum amount of pollutants and of unburned substances; and
adjusting the introduction in the combustion chamber and the cooling channel of an amount of recirculation air such as to allow conveying dry air at a preset temperature to the drying device.

12. Method according to claim 11, further comprising the step of maintaining the fuel inside the combustion chamber for a period of time that is greater than a second, so that said combustion chamber operates to complete the oxidation of the fuel in said combustion chamber and the emission of a minimum amount of pollutants and of unburned substances.

13. Method according to claim 11, wherein the fuel is selected from the group consisting of:
natural gas;
LPG; and
fuels with a lower heat value than natural gas and LPG, obtained from biomass, from municipal solid waste or from industrial waste and supplied in the form of gas, and in the nebulised liquid form.
